(19) United States
(12) Patent Application Publication
(10) Pub. No.: US 2015/0352757 A1
(43) Pub. Date: Dec. 10, 2015

(54) PARTICLE FOAM COMPONENT HAVING INTEGRATED FASTENING AND METHOD FOR PRODUCTION THEREOF

(71) Applicant: KRALLMANN KUNSTSTOFFVERARBEITUNG GMBH, Hiddenhausen (DE)

(72) Inventors: Ingo BREXELER, Wetter/Ruhr (DE); Roland ZEIFANG, Steinach (DE); Thomas DOLL, Oberkirch (DE)

(73) Assignee: Krallmann Kunststoffverarbeitung GmbH, Hiddenhausen (DE)

(21) Appl. No.: 14/763,317

(22) PCT Filed: Jan. 22, 2014
(86) PCT No.: PCT/EP2014/000158

§ 371 Date: Jul. 24, 2015

(30) Foreign Application Priority Data
Jan. 25, 2013 (DE) 10 2013 001 233.3

(51) Int. Cl. B29C 44/12; F16B 11/00

(52) U.S. Cl. CPC B29C 44/12; F16B 11/006; B29L 2031/727

(57) ABSTRACT

In a particle foam component with an embedded fastening element consisting of a thermoplastic or elastomeric plastic, the fastening element is surrounded at least in some sections by a wrapping consisting of a first particle foam of a first plastic. A bonding in substance and/or a positive-locking connection is brought about in a first contact surface between the fastening element and the wrapping. The wrapping is surrounded at least in some sections by a molded part made of a particle foam of a second plastic, and a bonding in substance is brought about in a second contact surface between the wrapping and the molded part.

### CROSS REFERENCE TO RELATED APPLICATIONS

This application is a United States National Phase application of International Application PCT/EP2014/000158 filed Jan. 22, 2014 and claims the benefit of priority under 35 U.S.C. §119 of German Patent Application DE 10 2013 001 233.3 filed Jan. 25, 2013, the entire contents of which are incorporated herein by reference.

### FIELD OF THE INVENTION

The present invention pertains to a particle foam component having an embedded fastening element made of a thermoplastic or elastomeric plastic.

The present invention pertains, furthermore, to a method for producing a particle foam component with embedded fastening device as well as to a fastening device to be inserted into a particle foam component.

### BACKGROUND OF THE INVENTION

Various embodiments of particle foam components made of foamed plastic are known and used in many areas in industry, because they have considerable advantages concerning weight and insulation. They are frequently used, for example, in the automobile industry to reduce weight compared to metallic components or as insulating components against sound, heat or mechanical stress. However, it is disadvantageous that it is relatively difficult to arrange a fastening element that transmits sufficiently strong forces on the particle foam component.

It is known that a dowel can be screwed as a fastening into a particle foam component, but a dowel can absorb only weak forces and there is a risk that it will be torn out under stress.

It is known, as an alternative, that a fastening element can be prefabricated and covered with the particle foam. The connection between the fastening and the foam is achieved by means of positive-locking connection, but this requires large surfaces and consequently a large amount of material and a heavy weight to be able to transmit sufficient forces.

### SUMMARY OF THE INVENTION

A basic object of the present invention is to provide a particle foam component in which a fastening element is received securely in the particle foam component in a simple manner. Furthermore, a method shall be provided, with which a corresponding particle foam component can be produced in a simple manner.

Furthermore, a fastening device to be inserted into a particle foam component, which can be subjected to further processing in a simple manner, shall be provided.

The above-mentioned object is accomplished according to the present invention in terms of the particle foam component by a particle foam component. Provisions are made here for the fastening element, which consists of a preferably compacted thermoplastic or elastomeric plastic, to be surrounded at least in some sections by a wrapping made of a first particle foam of a first plastic, and there is a bonding in substance and/or a positive-locking connection in a first contact surface between the fastening element and the wrapping, and for at least the wrapping to be surrounded, at least in some sections, by a molded part made of a second particle foam of a second plastic, and there is a bonding in substance in a second contact surface between the wrapping and the molded part.

The present invention is based on the basic idea that the fastening element, which may be, for example, a dowel or a locking pin or a threaded rod, is not connected or is not connected exclusively to the second particle foam, which forms the molded part and thus the component proper, but a wrapping made of a first particle foam is inserted between them. The wrapping is connected to the fastening element by bonding in substance and/or a positive-locking connection, so that relatively strong forces can be transmitted at this first contact surface.

The connection between the molded part made of the second particle foam and the wrapping made of the first particle foam has a relatively large surface and there is a bonding in substance. Based on this relatively large second contact surface between the wrapping and the molded part, there are substantially more possibilities for selecting the second particle foam, because this does not have to be selected according to the criterion that it must transmit strong forces via a relatively small surface with the fastening element.

In addition, there is an advantage that the fastening element with the wrapping can be prefabricated and surrounded later with the second particle foam forming the molded part.

The properties of the first particle foam used to form the wrapping may be selected especially such that this particle foam will form a good bond in substance and/or a positive-locking connection with the material of the fastening element. The first plastic forming the first particle foam is preferably an expanded polypropylene (EPP) or an expanded polystyrene (EPS).

The second plastic of the molded part forming the second particle foam is selected mainly depending on the properties and strengths the molded part shall have. The second plastic is preferably an expanded polypropylene (EPP) or an expanded polystyrene (EPS).

Provisions are made in a variant of the present invention for the first plastic and the second plastic to consist of different materials. This will usually be the case because the first plastic has especially the task of forming a good positive-locking connection with the plastic material of the fastening element and of forming a large-surface wrapping, which provides a large-surface second contact surface for connection to the molded part. The second plastic forms the molded part and is selected especially in view to the desired strength and insulation properties of the molded part as well as in view to a good connection with the wrapping.

However, provisions may also be made in a possible embodiment of the present invention for the first plastic and the second plastic to consist of identical materials, for example, EPP or EPS, but the materials possess different properties. The different properties may be especially a different density and/or a different color.

In terms of the method, the above-mentioned object is accomplished by a fastening device being formed from a fastening element, which consists of a thermoplastic or elastomeric plastic, and a wrapping, which surrounds the fastening element at least partially and is made of a first particle foam of a first plastic, and there is a bonding in substance and/or a positive-locking connection in a first contact surface between the fastening element and the wrapping. In a next step of the method, the fastening element provided with the wrapping is placed into a mold and at least the wrapping is surrounded with a molded part made of a second particle foam of a second plastic, and a bonding in substance is brought about in a second contact surface between the wrapping and the molded part.

Further features and advantages of the method appear from the description given above or below, to which reference will be made to avoid repetitions.

Furthermore, the above-mentioned object is accomplished according to the present invention by a fastening device to be inserted into a particle foam component, which has a fastening element made of a preferably compacted thermoplastic or elastomeric plastic and a wrapping, which surrounds the fastening element at least in some sections and is made of a first particle foam of a first plastic, and there is a bonding in substance and/or a positive-locking connection in a first contact surface between the fastening element and the wrapping.

The fastening device may be preferably manufactured according to the two-component injection molding method. It is possible here, on the one hand, to mold first the wrapping made of the first particle foam and then to inject the fastening element into the wrapping in a subsequent step of the method, but it is also possible, on the other hand, to mold the fastening element first and to inject the wrapping made of the first particle foam onto it in a subsequent step of the method. As an alternative, the fastening element may be prefabricated and then surrounded with and connected to the wrapping made of the first particle foam by injection molding.

The first plastic is preferably an expanded polypropylene (EPP) or an expanded polystyrene (EPS).

Provisions are made in a possible embodiment of the present invention for the wrapping to fully surround the fastening element, as result of which relatively strong forces can be transmitted.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a top view of a fastening device according to the present invention;

FIG. 2 is a sectional view through the fastening device according to FIG. 1;

FIG. 3 is a top view of a particle foam component according to the present invention in a schematic view; and

FIG. 4 is a sectional view through the particle foam component according to FIG. 3.

### DESCRIPTION OF THE PREFERRED EMBODIMENTS

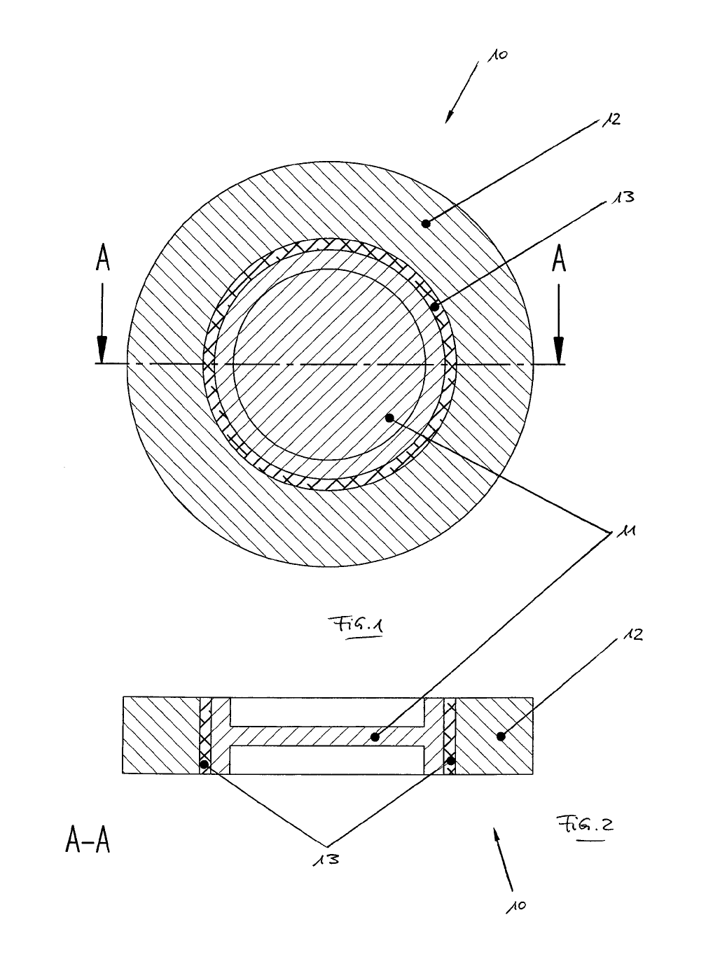

FIGS. 1 and 2 show a fastening device 10 to be inserted into a particle foam component. The fastening device 10 comprises a central fastening element 11, which is shown only schematically, may be, for example, an assembly plug or mounting stud and consists of a preferably compacted thermoplastic or elastomeric plastic. The fastening element 11 has an essentially regular cylindrical shape and is fully surrounded on its circumferential or jacket surface by a wrapping 12, which is made of a first particle foam of a first plastic. The first plastic may be an expanded polypropylene (EPP) or an expanded polystyrene. The wrapping 12 is in connection with the fastening element 11 at a first contact surface 13, and there is a bonding in substance and/or a positive-locking connection at the first contact surface 13 between the fastening element 11 and the wrapping 12. The fastening device 10 thus has the shape of wheel, in which the fastening element 11 forms the hub and the wrapping 12 the tire.

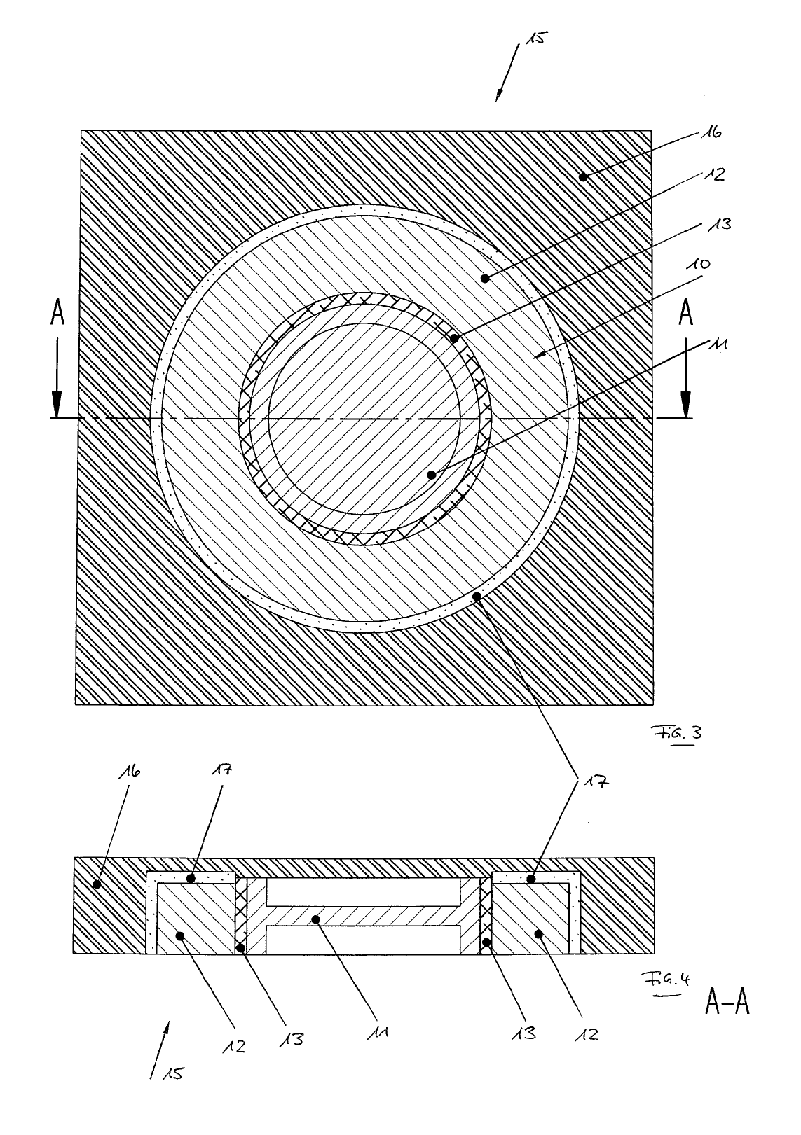

To manufacture a particle foam component 15 shown schematically in FIGS. 3 and 4, the prefabricated fastening device 10, i.e., the fastening element 11 with the wrapping 12 connected thereto by bonding in substance and/or a positive-locking connection, is placed into a mold and surrounded by means of a second particle foam made of a second plastic, wherein the fastening element 11 remains free on at least one side. The second particle foam forms a molding 16, which may be, for example, a plate, as this is indicated in FIGS. 3 and 4. The second particle foam of the second plastic is in connection with the wrapping 12 at a second contact surface 17, and there is a bonding in substance in the second contact surface 17 between the wrapping 12 and the molded part 16.

The second plastic forming the second particle foam may also be an expanded polypropylene (EPP) or an expanded polystyrene (EPS).

While specific embodiments of the invention have been shown and described in detail to illustrate the application of the principles of the invention, it will be understood that the invention may be embodied otherwise without departing from such principles.

1. A particle foam component, comprising:
an embedded fastening element, wherein the fastening element is surrounded at least in some sections by a wrapping comprising a first particle foam of a first plastic, wherein at least the wrapping is surrounded at least in some sections by a molded part comprising a second particle foam of a second plastic, the fastening element comprising a thermoplastic or elastomeric plastic, wherein a bonding in substance or a positive-locking connection and a bonding in substance is provided in a first contact surface between the fastening element and the wrapping, and a bonding in substance is provided in a second contact surface between the wrapping and the molded part.

2. A particle foam component in accordance with claim 1, wherein the first plastic is an expanded polypropylene (EPP) or an expanded polystyrene (EPS).

3. A particle foam component in accordance with claim 1, wherein the second plastic is an expanded polypropylene (EPP) or an expanded polystyrene (EPS).

4. A particle foam component in accordance with claim 1, wherein the first plastic and the second plastic comprise different materials.

5. A particle foam component in accordance with claim 1, wherein the first plastic and the second plastic comprise the same materials, the same materials possessing different properties.

6. A particle foam component in accordance with claim 5, wherein the materials have one or more of a different density and a different color.

7. A method for producing a particle foam component, the method comprising:
forming an embedded fastening device from a fastening element made of a thermoplastic or elastomeric plastic and a wrapping, which at least partially surrounds the fastening element and said wrapping is made of a first particle foam of a first plastic, and a bonding in substance or a positive-locking connection and a bonding in substance is brought about in a first contact surface between the fastening element and the wrapping, wherein the fastening element provided with the wrapping is subsequently placed into a mold and at least the wrapping is surrounded with a molded part made of a second particle foam of a second plastic, and a bonding in substance is brought about in a second contact surface between the wrapping and the molded part.

8. A fastening device to be inserted into a particle foam component, the fastening device comprising:
a fastening element comprising plastic; and
a wrapping, which surrounds the fastening element at least in some sections and said wrapping is made of a first particle foam of a first plastic, the fastening element comprising a thermoplastic or elastomeric plastic, wherein a bonding in substance or a positive-locking connection and a bonding in substance is provided in a first contact surface between the fastening element and the wrapping.

9. A fastening device in accordance with claim 8, wherein the first plastic is an expanded polypropylene (EPP) or an expanded polystyrene (EPS).

10. A fastening device in accordance with claim 8, wherein the wrapping completely surrounds the fastening element.

11. A fastening device in accordance with claim 9, wherein the wrapping completely surrounds the fastening element.

12. A particle foam component in accordance with claim 2, wherein the second plastic is an expanded polypropylene (EPP) or an expanded polystyrene (EPS).

13. A particle foam component in accordance with claim 2, wherein the first plastic and the second plastic comprise different materials.

14. A particle foam component in accordance with claim 3, wherein the first plastic and the second plastic comprise different materials.

15. A particle foam component in accordance with claim 2, wherein the first plastic and the second plastic comprise the same materials, the same materials possessing different properties.

16. A particle foam component in accordance with claim 3, wherein the first plastic and the second plastic comprise the same materials, the same materials possessing different properties.
